(19) United States
(12) Patent Application Publication
(10) Pub. No.: US 2026/0100817 A1
(43) Pub. Date: Apr. 9, 2026

(54) CONTROL METHOD OF SYSTEM FOR PROVIDING RESULTS OF HOMOMORPHIC ENCRYPTION OPERATIONS TO CONSUMER, AND NON-TRANSITORY COMPUTER-READABLE MEDIUM STORING INSTRUCTIONS FOR EXECUTING THE SAME

(71) Applicant: CRYPTO LAB INC., Seoul (KR)

(72) Inventors: Michael Pak, Portland, OR (US); Taekyung Kim, Seoul (KR)

(21) Appl. No.: 19/350,243

(22) Filed: Oct. 6, 2025

(30) Foreign Application Priority Data
Oct. 8, 2024 (KR) 10-2024-0136885
Sep. 15, 2025 (KR) 10-2025-0131479

(51) Int. Cl. H04L 9/00; H04L 9/06; H04L 9/08

(52) U.S. Cl. CPC H04L 9/008; H04L 9/0631; H04L 9/0825

(57) ABSTRACT

Provided are a control method of a system for providing results of homomorphic encryption operations to a consumer and a non-transitory computer-readable medium storing instructions for executing the same. The control method includes: generating, by a producer device, a secret key; generating, by the producer device, an encryption key and a set of operation keys from the secret key; obtaining, by the producer device, a homomorphic ciphertext by encrypting plaintext data using the secret key, and transmitting the homomorphic ciphertext and the set of operation keys to a processor device; obtaining, by the producer device, a plurality of divided keys from the secret key, and allocating the plurality of divided keys to a plurality of decryptor devices, respectively; transmitting, by the producer device, the encryption key to a consumer device; encrypting, by the consumer device, input data and transmitting the encrypted input data to the processor device; performing, by the processor device, a homomorphic encryption operation by using the homomorphic ciphertext and the encrypted input data; transmitting, by the processor device, an operation result ciphertext of the homomorphic encryption operation to the plurality of decryptor devices; obtaining, by the plurality of decryptor devices, a decrypted result value from the operation result ciphertext by using the plurality of divided keys; and transmitting, by the plurality of decryptor devices, the obtained result value to the consumer device.

### TECHNICAL FIELD

The present disclosure relates to a control method of a system for providing results of homomorphic encryption operations to a consumer and a non-transitory computer-readable medium storing instructions for executing the same.

### BACKGROUND ART

As communication technology advances and the distribution of electronic apparatuses becomes active, efforts to maintain communication security between electronic apparatuses have been continuously made. Accordingly, in most communication environments, encryption/decryption technology is used.

If a message encrypted by encryption technology is delivered to a counterpart, the counterpart is required to perform decryption to use the message. In this case, waste of resources and time may occur in a process of decrypting the encrypted data by the counterpart. In addition, if hacking by a third party occurs while the counterpart temporarily decrypts the message for operation, the message may be easily leaked to the third party.

To solve such problems, a homomorphic encryption method is being researched. According to a homomorphic encryption, the same result as a value obtained by performing an operation on a plaintext and then encrypting the value may be obtained even if the operation is performed on a ciphertext itself without decrypting the encrypted information. Therefore, various operations may be performed without decrypting the ciphertext.

Meanwhile, a system for providing a result of a homomorphic encryption operation to a consumer may include a producer device that generates and holds data, a processor device that processes homomorphically encrypted data (e.g., operations), and a consumer device that uses the processed data. For example, in the simplest scenario of applying the homomorphic encryption, the producer device and the consumer device may be implemented as the same device, sensitive information held by this device may be homomorphically encrypted and transmitted to the processor device, and the processor device may perform an operation by proxy using high computing power. This configuration may be referred to as an outsourced encrypted computing model. In this model, even if the processor device has a low level of security strength, if the producer or consumer device has high security, a secret key used for the homomorphic encryption operation may be safely protected. Conversely, in terms of computing power, the processor device often has high operational functions and computing power, thereby outsourcing complex operations.

However, in many other cases, the producer device and the consumer device may be implemented as different devices. For example, an object to be protected may be a weight value for a model of machine learning. In one example, the producer device may provide the weight value and the consumer devices may perform only a simple function of requesting an operation as a mere user. In another example, the object to be protected may be a database including sensitive data such as facial information, and the consumer devices such as a user's mobile phone may be required to deliver an encrypted query to the processor device each time for authentication and receive an operation result. In this case, the most significant problem may arise from the fact that a result of a homomorphic encryption operation is a ciphertext, and the result is accessed only if a secret key is present. In general, the consumer devices have very low levels of security strength, such as terminal devices, and if the consumer device itself is required to store the secret key, overall security strength of the system may be replaced with the low level of security strength of the consumer device, thereby eliminating the significance of using a homomorphic encryption itself.

As described above, if the producer device and the consumer device are different devices, a search for a measure is required in which the producer device does not relinquish its ownership of data while being able to adjust the security strength to a desired level.

### DISCLOSURE OF INVENTION

### Solution to Problem

According to an embodiment of the present disclosure, provided is a control method of a system for providing results of homomorphic encryption operations to a consumer, the method including: generating, by a producer device, a secret key; generating, by the producer device, an encryption key and a set of operation keys from the secret key; obtaining, by the producer device, a homomorphic ciphertext by encrypting plaintext data, and transmitting the homomorphic ciphertext and the set of operation keys to a processor device; obtaining, by the producer device, a plurality of divided keys from the secret key, and allocating the plurality of divided keys to a plurality of decryptor devices, respectively; transmitting, by the producer device, the encryption key to a consumer device; encrypting, by the consumer device, input data and transmitting the encrypted input data to the processor device; performing, by the processor device, a homomorphic encryption operation by using the homomorphic ciphertext and the encrypted input data; transmitting, by the processor device, an operation result ciphertext of the homomorphic encryption operation to the plurality of decryptor devices; obtaining, by the plurality of decryptor devices, a decrypted result value from the operation result ciphertext by using the plurality of divided keys; and transmitting, by the plurality of decryptor devices, the obtained result value to the consumer device.

The secret key may have an algebraic structure, and in the allocating, the secret key may be divided into a plurality of divided secret keys and the plurality of divided secret keys may be allocated to the plurality of decryptor devices, respectively.

In the allocating, divided key switching keys may be allocated to the remaining decryptor devices among the plurality of decryptor devices except for the last decryptor device, and a decryption key may be allocated to the last decryptor device among the plurality of decryptor devices.

In obtaining of the decrypted result value, the decrypted result value may be obtained by the plurality of decryptor devices by using a threshold fully homomorphic encryption (Threshold FHE) scheme.

The plurality of decryptor devices may be disposed to be physically separated from each other.

In the encrypting of the input data and the transmitting of the encrypted input data to the processor device, the input data may be encrypted by the consumer device using advanced encryption standard (AES) symmetric key encryption.

The plaintext data may include a weight of an artificial intelligence model or a vector database.

The number of decryptor devices may be determined by the producer device based on a security strength.

The secret key may be maintained by the producer device to be within the producer device not to be leaked externally.

According to an embodiment of the present disclosure, provided is a non-transitory computer-readable medium storing instructions for executing a control method of a system for providing results of homomorphic encryption operations to a consumer, wherein the method includes: generating, by a producer device, a secret key; generating, by the producer device, an encryption key and a set of operation keys from the secret key; obtaining, by the producer device, a homomorphic ciphertext by encrypting plaintext data, and transmitting the homomorphic ciphertext and the set of operation keys to a processor device; obtaining, by the producer device, a plurality of divided keys from the secret key, and allocating the plurality of divided keys to a plurality of decryptor devices, respectively; transmitting, by the producer device, the encryption key to a consumer device; encrypting, by the consumer device, input data and transmitting the encrypted input data to the processor device; performing, by the processor device, a homomorphic encryption operation by using the homomorphic ciphertext and the encrypted input data; transmitting, by the processor device, an operation result ciphertext of the homomorphic encryption operation to the plurality of decryptor devices; obtaining, by the plurality of decryptor devices, a decrypted result value from the operation result ciphertext by using the plurality of divided keys; and transmitting, by the plurality of decryptor devices, the obtained result value to the consumer device.

### BRIEF DESCRIPTION OF DRAWINGS

FIG. 1 is a diagram illustrating a system for providing results of homomorphic encryption operations to a consumer according to an embodiment of the present disclosure.

FIG. 2 is a block diagram illustrating a brief configuration of a producer device according to an embodiment of the present disclosure.

FIG. 3 is a block diagram illustrating a detailed configuration of the producer device according to an embodiment of the present disclosure.

FIG. 4 is a sequence diagram illustrating a control method of the system according to an embodiment of the present disclosure.

FIG. 5 is a diagram illustrating a method in which a plurality of decryptor devices decrypt an operation result ciphertext according to an embodiment of the present disclosure.

### MODE FOR INVENTION

Hereinafter, the present disclosure is described in detail with reference to the accompanying drawings. Encryption/decryption may be applied as necessary to a process of transmitting information (or data) that is performed in the present disclosure, and an expression describing the process of transmitting the information (or data) in the present disclosure and the claims should be interpreted as including all cases of the encryption/decryption even if not separately mentioned. In the present disclosure, an expression such as “transmission (delivery) from A to B” or “reception from A to B” may include transmission (delivery) or reception while having another medium included in the middle, and may not necessarily express only the direct transmission (delivery) or reception from A to B.

In describing the present disclosure, a sequence of each step should be understood as non-restrictive unless a preceding step in the sequence of each step needs to logically and temporally precede a subsequent step. That is, except for the above exceptional case, the essence of the present disclosure is not affected even if a process described as the subsequent step is performed before a process described as the preceding step, and the scope of the present disclosure should also be defined regardless of the sequences of the steps. In addition, in the specification, “A or B” may be defined to indicate not only selectively indicating either A or B, but also including both A and B. In addition, a term “including” in the present disclosure may encompass a concept of further including other components in addition to components listed as being included.

The present disclosure only describes essential components necessary for describing the present disclosure, and does not mention components unrelated to the essence of the present disclosure. In addition, it should not be interpreted as an exclusive concept that the present disclosure includes only the mentioned components, and should be interpreted as a non-exclusive concept that the present disclosure may include other components as well.

In addition, in the present disclosure, a “value” may be defined as a concept that includes a vector as well as a scalar value. In addition, in the present disclosure, an expression such as “calculate” or “compute” may be replaced with an expression that generates a result of the corresponding computation or calculation. In addition, unless otherwise indicated, an operation on a ciphertext described below refers to a homomorphic encryption operation. For example, addition on homomorphic ciphertexts indicates homomorphic addition on two homomorphic ciphertexts.

Mathematical operations and computations in each step of the present disclosure described below may be implemented as computer operations by a known coding method and/or coding designed to be appropriate for the present disclosure to perform the corresponding operations or computations.

Specific equations described below are illustratively provided among possible alternatives, and the scope of the present disclosure should not be construed as being limited to the equations mentioned in the present disclosure.

For convenience of description, the present disclosure defines the following notations.

a←D: Select an element a based on distribution D.

s1, s2∈R: Each of s1 and s2 is an element belonging to a set R.

mod (q): Perform a modular operation with an element q.

└⋅┐: Round an internal value.

Hereinafter, various embodiments of the present disclosure are described in detail with reference to the accompanying drawings.

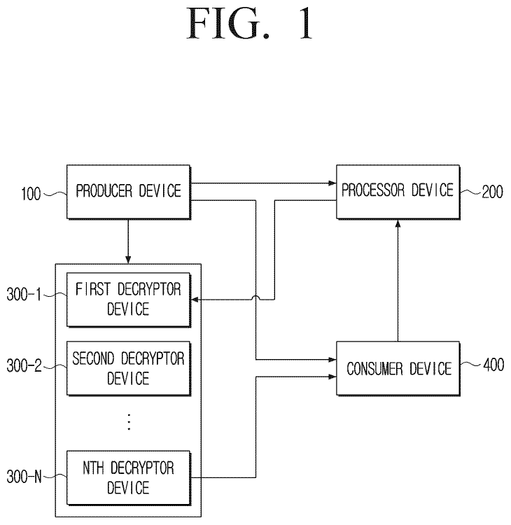

FIG. 1 is a diagram illustrating a system for providing results of homomorphic encryption operations to a consumer according to an embodiment of the present disclosure. As illustrated in FIG. 1, the system may include a producer device 100, a processor device 200, a plurality of decryptor devices 300-1, 300-2, . . . 300-N, and a consumer device 400, and the respective components may be connected to each other through a network 10.

The network 10 may be implemented as any of various types of wired/wireless communication networks, broadcast communication networks, optical communication networks, cloud networks, or the like, and each device may also be connected without a separate medium by a method such as wireless-fidelity (Wi-Fi), Bluetooth, or near field communication (NFC).

FIG. 1 illustrates that one producer device 100 is used, the present disclosure is not necessarily limited to one device, and a plurality of devices may be used. For example, the producer device 100 may be implemented as any of various types of devices such as a server, a smartphone, a tablet, a game player, a personal computer (PC), a laptop PC, a home server, or a kiosk, and may also be implemented as a home appliance type having internet of things (IoT) functions applied thereto.

The producer device 100 may generate a secret key (sk) for decrypting a homomorphic ciphertext, and generate an encryption key (ek) and a set of various operation keys (evk) accompanying the secret key.

The producer device 100 may generate or receive various information. For example, the producer device 100 may obtain information about an artificial intelligence model suitable for business logic (e.g., a vector database or a weight) or information about a circuit M. Here, the input or generated information may be referred to as plaintext data (or a plaintext message), etc.

The input information may be stored in the producer device 100 itself, which is merely an embodiment, and for a reason such as storage capacity or security, the input information may be transmitted to an external device (e.g., an external server) and stored.

The producer device 100 may obtain a homomorphic ciphertext by homomorphically encrypting the input or generated information using a public key.

The producer device 100 may include, in the ciphertext, encryption noise, i.e., an error, occurring in a process of performing the homomorphic encryption. Specifically, the homomorphic ciphertext generated by the producer device 100 may be generated in a form in which a result value including the message and an error value is restored if decrypted later using the secret key.

For example, the homomorphic ciphertext generated by the producer device 100 may be generated in a form that satisfies the following property if decrypted using the secret key by the plurality of decryptor devices 300-1, 300-2, . . . 300-N.

$$Dec ( ct , sk ) = < ct , sk >= M + e ( mod q ) . \qquad < Equation 1 >$$

Here, <, > denotes an inner product operation (i.e., a usual inner product), ct denotes a ciphertext, sk denotes a secret key, M denotes a plaintext message, e denotes an encryption error value, and mod q denotes a ciphertext modulus. q needs to be selected to be greater than a result value M obtained by multiplying a scaling factor Δ by the message. If an absolute value of the error value e is sufficiently smaller than M, a decrypted value M+e of the ciphertext may be a value that may replace an original message by the same precision in a significant figure operation. In the decrypted data, the error may be disposed on the least significant bit (LSB), and M may be disposed on the next least significant bit.

If a message size is too small or too large, the size may be adjusted using the scaling factor. If the scaling factor is used, not only an integer-type message but also a real-number-type message may be encrypted, and its usability may thus be greatly increased. In addition, the message size may be adjusted using the scaling factor to thus also adjust a size of an effective region, that is, a region where the messages are present in the ciphertext after the operation is performed.

According to an embodiment, the ciphertext modulus q may be set and used in various forms. For example, the ciphertext modulus may correspond to a value obtained by multiplying a plurality of different factors, and each factor may be set to a value within a range similar to that of the scaling factor.

In addition, the homomorphic ciphertext according to the present disclosure is described assuming that fixed point-numbers are used. However, the homomorphic ciphertext may also be applied even to a case where floating-point numbers are used.

The producer device 100 may transmit the homomorphic ciphertext and the set of operation keys (evk) to the processor device 200. Here, the processor device 200 may store the received homomorphic ciphertext in a ciphertext state without decryption. Accordingly, the processor device 200 may perform an operation without viewing the information held by the producer device 100.

In addition, the producer device 100 may transmit the encryption key (ek) to the consumer device 400.

Meanwhile, the homomorphic secret key (sk) has an algebraic structure, and may thus be divided into an arbitrary number of keys. That is, the secret key (sk) has a linear structure, and may thus be divided into an additively separable form. For example, the homomorphic secret key (sk) may be implemented in a form such as Equation 2 below.

$$sk = sk 1 + sk 2 + … + skN . \qquad < Equation 2 >$$

The producer device 100 may divide the secret key (sk) into a plurality of divided keys (e.g., sk1, sk2, . . . skN), and transmit the plurality of divided keys sk1, sk2, . . . skN to the plurality of decryptor devices 300-1, 300-2, . . . 300-N. According to an embodiment, the plurality of decryptor devices 300-1, 300-2, . . . 300-N may be disposed to be physically separated from each other.

Each of the plurality of decryptor devices 300-1, 300-2, . . . 300-N may store a corresponding divided key. For example, the first decryptor device 300-1 may store the first divided key sk1, the second decryptor device 300-2 may store the second divided key sk2, and the Nth decryptor device 300-N may store the Nth divided key skN.

Meanwhile, the divided key may be a key divided to enable the plurality of decryptor devices 300-1, 300-2, . . . 300-N to decrypt an operation result ciphertext. For example, the divided key may be a divided secret key obtained by dividing the secret key, which is merely an embodiment, and may also include a key switching key.

Here, the producer device 100 may maintain the secret key (sk) within the producer device 100 not to be leaked externally. That is, the producer device 100 may limit information of a high security level such as the secret key (sk) from being stored in regions other than the producer device 100 and the decryptor device 300.

That is, to decrypt the homomorphic ciphertext, it is necessary to access the secret key (sk) or sequentially access the plurality of decryptor devices 300-1, 300-2, . . . 300-N that store the plurality of divided keys sk1, sk2, . . . skN.

Meanwhile, the producer device 100 and the plurality of decryptor devices 300-1, 300-2, . . . 300-N may be implemented as separate devices, which is merely an embodiment, and may be implemented as a single device. Here, the plurality of decryptor devices 300-1, 300-2, . . . 300-N may be implemented as separate hardware regions within the device.

The producer device 100 may adjust a security strength through the plurality of decryptor devices 300-1, 300-2, . . . 300-N. For example, the producer device 100 may adjust the security strength by adjusting the number of decryptor devices 300-1, 300-2, . . . 300-N. For example, the producer device 100 may transmit one secret key (sk) without division to one decryptor device. In this case, the security strength may be low. However, the security strength may be increased by increasing the number of divisions of the secret key (sk).

The consumer device 400 may request a specific processing result of the homomorphic ciphertext from the processor device 200 using an input encrypted by the encryption key (ek). The processor device 200 may perform a specific operation based on the request of the consumer device 400, and then transmit the result to the first decryptor device 300-1 among the plurality of decryptor devices.

For example, if ciphertexts ct1 and ct2 transmitted by the producer device 100 are stored in the processor device 200, the consumer device 400 may request, from the processor device 200, a value obtained by adding information provided from the producer device 100. The processor device 200 may perform an operation of adding the two ciphertexts based on the request, and then transmit a result value (ct1+ct2) to the first decryptor device 300-1.

Due to the property of the homomorphic ciphertext, the processor device 200 may perform an operation without decryption, and the result value may also become a ciphertext. In the present disclosure, the result value obtained by an operation is referred to as the operation result ciphertext (or a homomorphic operation ciphertext).

The processor device 200 may transmit the operation result ciphertext to the first decryptor device 300-1. The plurality of decryptor devices 300-1, 300-2, . . . 300-N may sequentially decrypt the received operation result ciphertext using the plurality of divided keys, and obtain an operation result value of data included in each homomorphic ciphertext. In addition, the plurality of decryptor devices 300-1, 300-2, . . . 300-N may transmit the obtained operation result value to the consumer device 400. If necessary, the plurality of decryptor devices 300-1, 300-2, . . . 300-N may perform post-processing on the obtained operation result value and then transmit the processed result value to the consumer device 400.

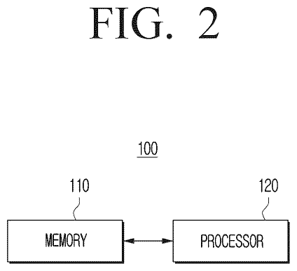

Referring to FIG. 2, the producer device 100 may include a memory 110 and a processor 120.

The memory 110 is a component for storing an operating system (O/S) for driving the producer device 100 or various instructions and/or software, data, or the like related to the generation and operation processing of the homomorphic ciphertext described below. The memory 110 may be implemented in any of various forms such as a random access memory (RAM), a read only memory (ROM), a flash memory, a hard disk drive (HDD), an external memory, or a memory card, and is not limited to any one of these forms.

The memory 110 may store a message to be encrypted. Here, the message may be information about the artificial intelligence model (or a neural network model) or information about a circuit, which is merely an embodiment, and may also be information related to usage history, such as various credit information cited by a user, personal information, location information used in the producer device 100, and internet usage time information.

Alternatively, the message may be a voice uttered by the user or a text resulting from a speech-to-text (STT) function performed on the above-described voice. Here, the message to be encrypted may be referred to as the plaintext data.

In addition, the memory 110 may store the public key, and if the electronic apparatus 100 corresponds to a device that directly generates the public key, the electronic apparatus 100 may store not only the secret key (sk) but also various parameters necessary for generating the public key and the secret key (sk).

In addition, the memory 110 may store the homomorphic ciphertext generated in a process described below. Here, the ciphertext stored in the memory 110 may be a learning-with-error (LWE) scheme-based ciphertext, and is not limited thereto.

The processor 120 may control each component in the producer device 100. The processor 120 may be implemented as a single device such as a central processing unit (CPU) or an application-specific integrated circuit (ASIC), or may be implemented as a plurality of devices such as a CPU and a graphics processing unit (GPU).

The processor 120 may store the plaintext data in the memory 110 upon receiving the plaintext data. The processor 120 may homomorphically encrypt the plaintext data using various setting values and programs stored in the memory 110. In this case, the processor 120 may use the public key.

The processor 120 may generate and use the public key necessary for performing encryption by itself, or may receive and use the public key from the external device.

Upon generating a key by itself, the processor 120 may generate the public key using a Ring-Learning With Errors (RLWE) scheme. To describe in detail, the processor 120 may first set various parameters and a ring and store the same in the memory 110. An example of the parameters may include a length of plaintext data bits, a dimension (n), a rank (k), a size of the public key or the secret key (sk), or the like. Various types of homomorphic ciphertexts may be present, and the processor 120 may set the ring based on a predetermined ciphertext scheme or a ciphertext scheme set by the user. For example, the above-described homomorphic ciphertext scheme may be a Cheon-Kim-Kim-Song (CKKS) scheme, the RLWE scheme, or the like.

The ring may be expressed as shown in Equation 3 below.

$$R = {Z}_{q} [ X ] / f ( x ) . \qquad < Equation 3 >$$

Here, R denotes a ring, Z_{q} denotes a coefficient, and f (x) denotes an nth-order polynomial.

The Ring refers to a set of polynomials having predetermined coefficients, in which addition and multiplication are defined among elements, and which is closed under addition and multiplication. The Ring may be referred to as the ring.

For example, the ring R refers to a set of nth-order polynomials having coefficients in Z_{q}. Specifically, if n is Φ(N), the ring denotes polynomials calculated as remainders after division by the N-th cyclotomic polynomial. (f(x)) refers to an ideal of Z_{q} [x] generated by f(x). The Euler totient function Φ(N) refers to the number of natural numbers that are coprime to N and smaller than N.

The ring used in the above-described intermediate ciphertext (MLWE) scheme may be expressed as shown in Equation 4 below.

$${R}_{q , N}^{k} = {( {ℤ}_{q} [ X ] / ( {X}^{N} + 1 ) )}^{k} \qquad < Equation 4 >$$

$$or ,$$

$${R}_{q , N}^{k} = {( {ℤ}_{q} [ X ( N ) ] / ( {X}_{( N )}^{N} + 1 ) )}^{k} .$$

Here, q denotes a modulus, k denotes a rank, and N denotes a dimension. Meanwhile, the above-described ring assumes the MLWE. Therefore, N may be substituted with 1 in case of using the LWE scheme, and k may be substituted with 1 in case of using the RLWE scheme.

If the ring is set in this way, the processor 120 may derive the secret key (sk) from the ring.

$$sk ← ( 1 , s ( x ) ) , s ( x ) ∈ R . \qquad < Equation 5 >$$

Here, s (x) denotes a polynomial randomly generated using small coefficients.

If the ring and the secret key (sk) are selected, the processor 120 may derive a first random polynomial a (x) from the ring. The first random polynomial may be expressed as follows.

$$a ( x ) ← R . \qquad < Equation 6 >$$

In addition, the processor 120 may derive the error. In detail, the processor 120 may extract the error from a discrete Gaussian distribution or a distribution statistically close thereto. The error may be expressed as follows.

$$e ( x ) ← Dn α q . \qquad < Equation 7 >$$

If the error is also derived, the processor 120 may derive a second random polynomial by performing a modular operation on the error by using the first random polynomial and the secret key (sk). The second random polynomial may be expressed as follows.

$$b ( x ) = - a ( x ) s ( x ) + e ( x ) ( mod q ) . \qquad < Equation 8 >$$

Finally, a public key (pk) may be set to a form including the first random polynomial and the second random polynomial as follows.

$$p k = ( b ( x ) , a ( x ) ) . \qquad < Equation 9 >$$

Meanwhile, the contents of Equations 5 to 9 are examples of using a CKKS scheme method (where the CKKS scheme is an example based on the RLWE scheme), and in case of using the LWE or MLWE scheme, the above-described method may be modified to suit the corresponding scheme. In addition, the public key and the secret key may also be generated using another method in addition to the above-described method.

In addition, the processor 120 may generate the homomorphic ciphertext of a message. In detail, the processor 120 may generate the homomorphic ciphertext of a message by applying the previously generated public key.

According to at least one embodiment, the processor 120 may divide the secret key (sk) into a plurality of divided keys to obtain the plurality of divided keys. In detail, the secret key (sk) has an algebraic structure (e.g., the linear structure), and the processor 120 may thus divide the secret key into a plurality of divided secret keys based on the security strength, and allocate the plurality of divided secret keys to the plurality of decryptor devices 300-1, 300-2, . . . 300-N, respectively.

According to at least one embodiment, the processor 120 may generate at least one key switching key in addition to the secret key (sk), and allocate the generated at least one key switching key and the secret key to the plurality of decryptor devices 300-1, 300-2, . . . 300-N. In this case, at least some of the plurality of decryptor devices may perform a key switching operation, and the remaining some may perform a decryption operation using the secret key (or the divided secret keys). For example, the processor 120 may allocate the divided key switching keys to the remaining decryptor devices among the plurality of decryptor devices 300-1, 300-2, . . . 300-N except for the last decryptor device, and allocate a decryption key to the last decryptor device 300-N among the plurality of decryptor devices 300-1, 300-2, . . . 300-N.

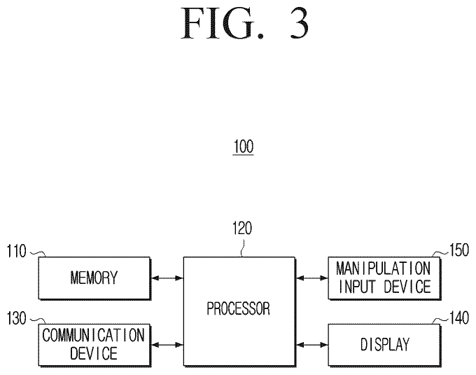

FIG. 3 is a block diagram illustrating a detailed configuration of the electronic apparatus according to an embodiment of the present disclosure.

Referring to FIG. 3, the producer device 100 according to the present disclosure may include the memory 110, the processor 120, a communication device 130, a display 140, and a manipulation input device 150.

The description of the memory 110 is provided with reference to FIG. 2, and a redundant description thereof is thus omitted. The description of the processor 120 is also provided with reference to FIG. 2, and only additional functions of the processor 120 with reference to FIG. 3 are described without redundantly stating the contents with reference to FIG. 2.

The communication device 130 may be provided to connect the producer device 100 with the external device (not shown), and may not only be connected to the external device through a local area network (LAN) or the internet network, but may also be connected through a universal serial bus (USB) port or a wireless communication port (e.g., Wi-Fi 802.11a/b/g/n, NFC, or Bluetooth). The communication device 130 may also be referred to as a transceiver.

The communication device 130 may receive the public key from the external device and may transmit the public key generated by the producer device 100 to the external device.

In addition, the communication device 130 may receive a message from the external device and may transmit the generated homomorphic ciphertext to the external device (e.g., the processor device 200). Conversely, the communication device 130 may also receive the ciphertext from the external device.

In addition, the communication device 130 may receive various parameters necessary for generating the ciphertext from the external device. Meanwhile, in implementation, the various parameters may be directly received from the user through the manipulation input device 150 described below.

In addition, the communication device 130 may receive a pre-trained model or a weight matrix included in the above-described model from an external source.

The display 140 may display a user interface window for selecting functions supported by the producer device 100. In detail, the display 140 may display the user interface window for selecting various functions provided by the producer device 100. The display 140 may be implemented as a monitor such as a liquid crystal display (LCD), a cathode ray tube (CRT), or an organic light-emitting diode (OLED), and may also be implemented as a touchscreen capable of simultaneously performing functions of the manipulation input device 150 described below.

The display 140 may display a message requesting input of parameters necessary for generating the secret key and the public key. In addition, the display 140 may display a message for selecting the message to be encrypted. Meanwhile, in implementation, the message to be encrypted may be directly selected by the user or may be automatically selected. That is, personal information or the like to be encrypted may be automatically set even if the user does not directly select a message.

The manipulation input device 150 may receive function selection of the producer device 100 and control commands for the corresponding function from the user. In detail, the manipulation input device 150 may receive, from the user, parameters necessary for generating the secret key and the public key. In addition, the manipulation input device 150 may receive the message to be encrypted from the user.

In addition, the manipulation input device 150 may receive selection of a trained model to be applied to the plurality of homomorphic ciphertexts. Based on such a selection command, the processor 120 may perform a matrix operation between the plurality of homomorphic ciphertexts and the weight matrix included in the selected trained model.

In addition, the manipulation input device 150 may receive a transmission command, a homomorphic operation command, a security strength setting command, or the like for the homomorphic ciphertext.

Upon receiving, from the user, the parameters necessary for generating the secret key and the public key, the processor 120 may generate set parameters based on the received parameters, and generate the secret key and the public key based on the generated set parameters.

In addition, if generation of the ciphertext of a message is required, the processor 120 may generate the homomorphic ciphertext by applying the public key to the message. In detail, the processor 120 may convert the message into a polynomial form and may generate the homomorphic ciphertext by applying the public key to the message converted into the polynomial form.

According to an embodiment, if decryption of the homomorphic ciphertext is required, the processor 120 may generate a polynomial-form plaintext by applying the secret key to the homomorphic ciphertext, and may generate the message by decoding the polynomial-form plaintext. Here, the generated message may include the error as described in Equation 1 above.

According to an embodiment, if an operation for the homomorphic ciphertext is required, the processor 120 may perform an addition or multiplication operation on a plurality of homomorphic ciphertexts requested by the user.

As described above, the producer device 100 according to this embodiment may generate the homomorphic ciphertext of a message, and thus may improve stability of the message even if an operation is required. In addition, the generated homomorphic ciphertext includes the error, thereby maintaining stable security even for biometric information or the like requiring a high level of security.

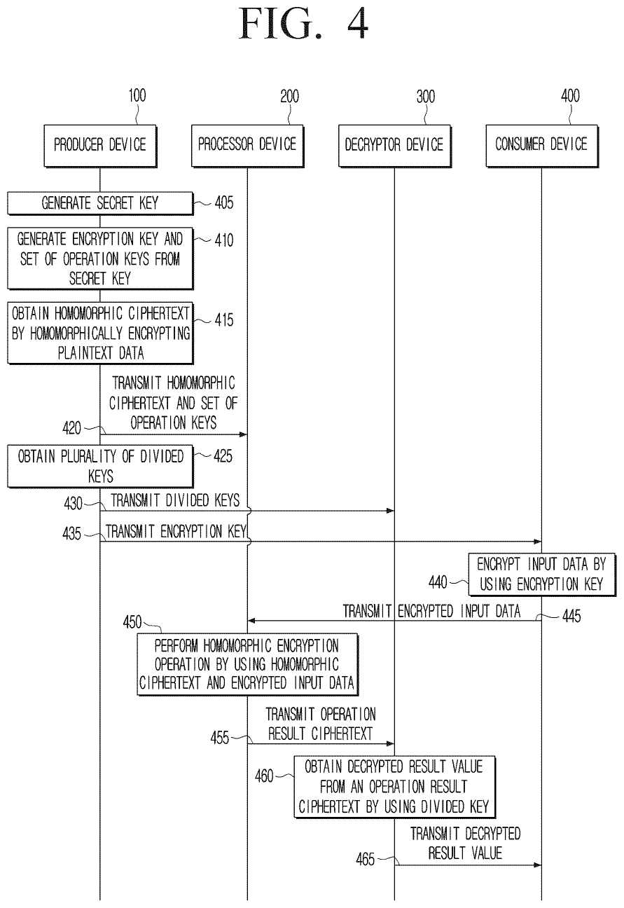

FIG. 4 is a sequence diagram illustrating a control method of the system according to an embodiment of the present disclosure.

In the following embodiment, each operation may be performed sequentially. However, the respective operations may not be necessarily performed sequentially. For example, the order of the respective operations may be changed, and at least two operations may be performed in parallel.

Referring to FIG. 4, the producer device 100 may generate the secret key (sk) (405). Here, the secret key (sk) refers to a key used for decrypting the homomorphic ciphertext and may be generated using parameters for generating the secret key (sk), which is merely an embodiment, and may be received from the external device.

The producer device 100 may generate the encryption key (ek) and the set of operation keys (evk) from the secret key (sk) (410). Here, the encryption key (ek) refers to a key for encrypting input data by the consumer device 400, and the set of operation keys (evk) may refer to a set of auxiliary keys generated to support an operation such as multiplication, rotation, key switching, or bootstrapping.

The producer device 100 may obtain the homomorphic ciphertext by homomorphically encrypting the plaintext data (415). According to an embodiment, the plaintext data may be a weight of the artificial intelligence model or the vector database, and is not limited thereto. In particular, the producer device 100 may homomorphically encrypt the plaintext data by using the public key.

The producer device 100 may transmit the homomorphic ciphertext and the set of operation keys to the processor device 200 (420).

The producer device 100 may obtain the plurality of divided keys (425).

According to at least one embodiment, the producer device 100 may divide the secret key having a linear structure into the plurality of divided secret keys. According to at least one embodiment, the producer device 100 may obtain at least one key switching key and the secret key (or the plurality of divided secret keys, or the like).

According to at least one embodiment, the producer device 100 may identify the number of divided secret keys based on the security strength set by the user, and may divide the secret key into the plurality of divided secret keys based on the identified number.

The producer device 100 may transmit the divided keys to the decryptor device 300 (430).

The producer device 100 may transmit the encryption key to the consumer device 400 (435).

The consumer device 400 may encrypt the input data by using the encryption key (440). According to an embodiment, the encryption key (ek) may be an advanced encryption standard (AES) symmetric key. In this case, after encrypting the input data by using the AES key, the consumer device 400 may protect the AES key by using the homomorphic encryption. Here, the input data may include information about the homomorphic encryption operation.

The consumer device 400 may transmit the encrypted input data to the processor device 200 (445).

The processor device 200 may perform the homomorphic encryption operation by using the homomorphic ciphertext and the encrypted input data (450). In this way, the processor device 200 may obtain an operation result ciphertext.

The processor device 200 may transmit the operation result ciphertext to the decryptor device 300 (455).

The decryptor device 300 may obtain a decrypted result value from an operation result ciphertext by using the divided key (460).

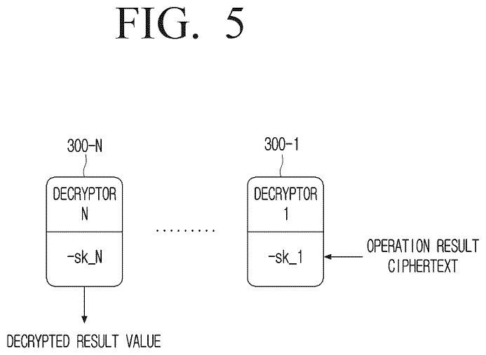

According to at least one embodiment, the decryptor device 300 may be implemented as a plurality of devices, and the plurality of decryptor devices 300-1, 300-2, . . . 300-N may sequentially decrypt the operation result ciphertext using the received divided secret keys to obtain the decrypted result value. For example, as illustrated in FIG. 5, the first decryptor device 300-1 may obtain the operation result ciphertext and may perform decryption on the obtained operation result ciphertext using a first divided secret key sk_1. In this way, the decryptor devices may sequentially perform decryption for the operation result ciphertext using the corresponding divided secret keys, and the decrypted result value may be obtained through the last decryptor device sk_N.

According to at least one embodiment, at least some of the plurality of decryptor devices 300-1, 300-2, . . . 300-N may perform the key switching operation by using the key switching key, and the remaining some may perform the decryption operation by using the secret key (or the divided secret key).

According to at least one embodiment, the plurality of decryptor devices 300-1, 300-2, . . . 300-N may obtain the decrypted result value by using a threshold fully homomorphic encryption (Threshold FHE) scheme. That is, each of a certain number or more of the plurality of decryptor devices 300-1, 300-2, . . . 300-N may perform partial decryption using the divided secret key, and may couple (combine) the partially decrypted values to obtain the result value.

The decryptor device 300 may transmit the decrypted result value to the consumer device 400 (465).

Although the various embodiments have been described above, the respective embodiments may not necessarily be implemented independently and may be entirely or partially combined with at least one other embodiment to be implemented together in a single product.

The various embodiments of the present disclosure may be implemented as software including instructions stored in machine-readable storage media. A machine may be a device that invokes the stored instructions from the storage medium and operates based on the instructions, and may include the electronic apparatuses 100 and 200 according to the disclosed embodiments.

For example, a non-transitory computer-readable storage medium storing software for sequentially performing the various steps as illustrated in FIG. 4 or FIG. 6 may be provided.

An apparatus equipped with the non-transitory computer-readable medium may perform the operations such as public key generation, encryption, and decryption described in the above-described various embodiments.

In the non-transitory computer-readable storage medium, the term “non-transitory” only indicates that the storage medium is tangible without including a signal, and does not distinguish whether data are semi-permanently or temporarily stored on the storage medium.

Alternatively, a program for performing the method according to the various embodiments described above may be distributed online via an application store. In case of the online distribution, at least portions of the computer program product may be at least temporarily stored on a storage medium such as the memory of a server of a manufacturer, a server of an application store or a relay server, or be temporarily generated.

Each of the components (e.g., modules or programs) according to the various embodiments may include a single entity or a plurality of entities, and some of the corresponding sub-components described above may be omitted or other sub-components may be further included in the various embodiments. Alternatively or additionally, some of the components (e.g., the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although the present disclosure has been described hereinabove with reference to the accompanying drawings, the scope of the present disclosure is determined based on the claims described below and should not be construed as being limited to the embodiments and/or drawings provided above. In addition, it should be clearly understood that improvements, changes, and modifications apparent to those skilled in the art of the present disclosure described in the claims are also included in the scope of the present disclosure.

1. A control method of a system for providing results of homomorphic encryption operations to a consumer, the method comprising:
generating, by a producer device, a secret key;
generating, by the producer device, an encryption key and a set of operation keys from the secret key;
obtaining, by the producer device, a homomorphic ciphertext by encrypting plaintext data, and transmitting the homomorphic ciphertext and the set of operation keys to a processor device;
obtaining, by the producer device, a plurality of divided keys from the secret key, and allocating the plurality of divided keys to a plurality of decryptor devices, respectively;
transmitting, by the producer device, the encryption key to a consumer device;
encrypting, by the consumer device, input data and transmitting the encrypted input data to the processor device;
performing, by the processor device, a homomorphic encryption operation by using the homomorphic ciphertext and the encrypted input data;
transmitting, by the processor device, an operation result ciphertext of the homomorphic encryption operation to the plurality of decryptor devices;
obtaining, by the plurality of decryptor devices, a decrypted result value from the operation result ciphertext by using the plurality of divided keys; and
transmitting, by the plurality of decryptor devices, the obtained result value to the consumer device.

2. The method of claim 1, wherein the secret key has an algebraic structure, and
in the allocating, the secret key is divided into a plurality of divided secret keys and the plurality of divided secret keys are allocated to the plurality of decryptor devices, respectively.

3. The method of claim 1, wherein in the allocating, divided key switching keys are allocated to the remaining decryptor devices among the plurality of decryptor devices except for the last decryptor device, and a decryption key is allocated to the last decryptor device among the plurality of decryptor devices.

4. The method of claim 1, wherein in obtaining of the decrypted result value, the decrypted result value is obtained by the plurality of decryptor devices by using a threshold fully homomorphic encryption (Threshold FHE) scheme.

5. The method of claim 1, wherein the plurality of decryptor devices are disposed to be physically separated from each other.

6. The method of claim 1, wherein in the encrypting of the input data and the transmitting of the encrypted input data to the processor device, the input data is encrypted by the consumer device using advanced encryption standard (AES) symmetric key encryption.

7. The method of claim 1, wherein the plaintext data includes a weight of an artificial intelligence model or a vector database.

8. The method of claim 1, wherein the number of decryptor devices is determined by the producer device based on a security strength.

9. The method of claim 1, wherein the secret key is maintained by the producer device to be within the producer device not to be leaked externally.

10. A non-transitory computer-readable medium storing instructions for executing a control method of a system for providing results of homomorphic encryption operations to a consumer, wherein the method includes:
generating, by a producer device, a secret key;
generating, by the producer device, an encryption key and a set of operation keys from the secret key;
obtaining, by the producer device, a homomorphic ciphertext by encrypting plaintext data, and transmitting the homomorphic ciphertext and the set of operation keys to a processor device;
obtaining, by the producer device, a plurality of divided keys from the secret key, and allocating the plurality of divided keys to a plurality of decryptor devices, respectively;
transmitting, by the producer device, the encryption key to a consumer device;
encrypting, by the consumer device, input data and transmitting the encrypted input data to the processor device;
performing, by the processor device, a homomorphic encryption operation by using the homomorphic ciphertext and the encrypted input data;
transmitting, by the processor device, an operation result ciphertext of the homomorphic encryption operation to the plurality of decryptor devices;
obtaining, by the plurality of decryptor devices, a decrypted result value from the operation result ciphertext by using the plurality of divided keys; and
transmitting, by the plurality of decryptor devices, the obtained result value to the consumer device.
